(19) United States
(12) Patent Application Publication
(10) Pub. No.: US 2013/0307767 A1
(43) Pub. Date: Nov. 21, 2013

(54) DISPLAY DEVICE AND DISPLAY METHOD

(71) Applicant: PANASONIC CORPORATION, Osaka (JP)

(72) Inventors: Kazunari FUJIWARA, Osaka (JP); Atsushi NARITA, Osaka (JP); Mika SAKAI, Shizuoka (JP); Shinichi SATO, Miyagi (JP); Naoyuki TSUBOI, Shizuoka (JP); Naoko KUREBAYASHI, Shizuoka (JP)

(73) Assignee: PANASONIC CORPORATION, Osaka (JP)

(21) Appl. No.: 13/949,030

(22) Filed: Jul. 23, 2013

Related U.S. Application Data
(63) Continuation of application No. PCT/JP2012/004239, filed on Jun. 29, 2012.

(30) Foreign Application Priority Data
Feb. 24, 2012 (JP) 2012-038455

(51) Int. Cl. G06F 3/03

(52) U.S. Cl. CPC G06F 3/03
USPC 345/156

(57) ABSTRACT

A display device in which continuity of content displayed on a screen is maintained between before and after a rotation of the screen, including: a display screen which is fixed to the display device and displays a partial region of an image; an operation detecting unit which specifies a position in the partial region of the image displayed on the display screen; a rotation detecting unit which detects rotation information which indicates a rotation of the display device in a plane including the display screen; and a display image determining unit which updates display content on the display screen to display the partial region of the image after the rotation on the display screen by rotating, based on the rotation information detected by the detecting unit, the partial region of the image around the position specified by the specifying unit.

### CROSS REFERENCE TO RELATED APPLICATIONS

This is a continuation application of PCT Patent Application No. PCT/JP2012/004239 filed on Jun. 29, 2012, designating the United States of America, which is based on and claims priority of Japanese Patent Application No. 2012-038455 filed on Feb. 24, 2012. The entire disclosures of the above-identified applications, including the specifications, drawings and claims are incorporated herein by reference in their entirety.

### FIELD

The present disclosure relates to a display device and a display method.

### BACKGROUND

In recent years, mobile information display terminals such as mobile phones, personal handy phone systems (PHSs), and personal digital assistants (PDAs) have increased functionalities. Such a mobile information display terminal has a web browser as in a personal computer (PC), and is capable of displaying a variety of content items such as images on the Internet. In general, a mobile information display terminal is small for the sake of mobility. As a result, the information display terminal has a limited screen size. When viewing content larger than the screen of the information display terminal, a user operates on a touch panel, etc. to move a display range so that a desired part is displayed on the display screen.

Moreover, display orientations of the screen of the information display terminal include a vertical orientation and a horizontal orientation. Here, the vertical orientation is a display orientation in which the short side of the screen is horizontal, and also called a portrait mode. The horizontal orientation is a display orientation in which the long side of the screen is horizontal, and also called a landscape mode. The above display orientations are referred to as horizontal and vertical orientations of the screen.

The user can view the content in a desired mode by switching the screen of the information display terminal between the horizontal orientation and the vertical orientation.

A technique for switching the display screen of the information display terminal between the horizontal orientation and the vertical orientation is disclosed (for example, Patent Literature (PTL) 1).

### CITATION LIST

### Patent Literature

[PTL 1] Japanese Unexamined Patent Application Publication No. 2006-208560

### SUMMARY

### Technical Problem

However, when switching the screen between the horizontal orientation and the vertical orientation by rotating the display screen while viewing a newspaper, a magazine, etc. on the information display terminal, a point on which the user focuses (point of focus) may move to a different position on the display screen or move out of the display screen. In such a case, the user needs to look for the position the user was focusing on before switching between the horizontal orientation and the vertical orientation by rotating the display screen, and then focus on the position again on the screen after the switching. That is, there is a problem of a discontinuity of the content displayed on the screen between before and after the rotation of the screen.

In view of the aforementioned problem, the present disclosure provides a display device in which continuity of the content displayed on the screen is maintained between before and after the rotation of the screen.

### Solution to Problem

A display device according to an aspect of the present disclosure is a display device including: a display screen which is fixed to the display device and displays a partial region of an image; a specifying unit configured to specify a position in the partial region of the image displayed on the display screen; a detecting unit configured to detect rotation information which indicates a rotation of the display device in a plane including the display screen; and an updating unit configured to update display content on the display screen to display the partial region of the image after the rotation on the display screen by rotating, based on the rotation information detected by the detecting unit, the partial region of the image around the position specified by the specifying unit. Moreover, a display device according to another aspect of the present disclosure is a display device including a display screen, the display device including: a rotation detecting unit configured to detect, as the rotation information, that the display screen is rotated in the plane including the display screen; an operation detecting unit configured to specify a specified position on the display screen, the specified position being specified through an operation by a user; a display image determining unit configured to determine, as a display image, an image included in a display region in a content image; and a display controlling unit configured to display the display image determined by the display image determining unit on the display screen, and when the rotation information is detected by the rotation detecting unit, the display image determining unit is configured to rotate, based on the rotation information, the display region around a center of rotation detected by the operation detecting unit, and determine an image included in the display region after the rotation as a new display image, the center of rotation being the specified position.

These general and specific aspects may be implemented using a system, a method, an integrated circuit, a computer program, or a computer-readable recording medium such as a CD-ROM, or any combination of systems, methods, integrated circuits, computer programs, or computer-readable recording media.

### Advantageous Effects

According to the present disclosure, a user can view content including newspapers and magazines on an information display terminal while switching the display screen between the horizontal orientation and the vertical orientation without losing a sight of the point of focus.

### BRIEF DESCRIPTION OF DRAWINGS

These and other advantages and features of the disclosure will become apparent from the following description thereof taken in conjunction with the accompanying drawings that illustrate a specific embodiment of the present disclosure.

FIG. 1 is a diagram showing an example of a hardware configuration of a display device according to an embodiment of the present disclosure.

FIG. 2 is a block diagram showing an example of a configuration of the display device according to the embodiment of the present disclosure.

FIG. 3 is a flowchart showing an example of operations of the display device according to the embodiment of the present disclosure.

FIG. 4 is a flowchart showing operations of a display image determining unit according to the embodiment of the present disclosure.

FIG. 5 is a diagram showing an example of display content on the display device.

FIG. 6 is a diagram for explaining operations to set a point of focus.

FIG. 7 is a diagram showing map data which is original data of the display content stored in a storing unit.

FIG. 8A is a diagram showing image regions before and after a rotation displayed on the display screen.

FIG. 8B is an illustration diagram of a process of calculating coordinates of the image regions before and after the rotation of the display screen.

FIG. 9 is a diagram showing the display device after the rotation.

FIG. 10 is a diagram showing display image regions in the original data in the case where a center point is set to the center of the display screen.

FIG. 11 is a diagram showing an example of the display content on the display device.

### DESCRIPTION OF EMBODIMENT

### (Underlying Knowledge Forming Basis of the Present Disclosure)

In relation to the switching of the screen of the information display terminal between the horizontal orientation and the vertical orientation disclosed in the Background Art section, the inventors have found a problem as described below.

With the technique disclosed in PTL 1, it is possible to fix a specific display position in a partial image region displayed on a display screen, rotate the display screen around the fixed specific display position in the partial image region, and display the partial image region in a virtual image region corresponding to the position of the display screen after the rotation.

However, when switching the screen between the horizontal orientation and the vertical orientation by rotating the display screen while viewing a newspaper, a magazine, etc. on the information display terminal, a point on which the user focuses (point of focus) may move to a different position on the display screen or move out of the display screen. In such a case, the user needs to look for the position the user was focusing on before switching between the horizontal orientation and the vertical orientation by rotating the display screen, and then focus on the position again in the screen after the switching. That is, there is a problem of a discontinuity of the content displayed on the screen between before and after the rotation of the screen.

In order to solve the aforementioned problem, a display device according to an aspect of the present disclosure is a display device including: a display screen which is fixed to the display device and displays a partial region of an image; a specifying unit configured to specify a position in the partial region of the image displayed on the display screen; a detecting unit configured to detect rotation information which indicates a rotation of the display device in a plane including the display screen; and an updating unit configured to update display content on the display screen to display the partial region of the image after the rotation on the display screen by rotating, based on the rotation information detected by the detecting unit, the partial region of the image around the position specified by the specifying unit. Moreover, a display device according to another aspect of the present disclosure is a display device including a display screen, the display device including: a rotation detecting unit configured to detect, as the rotation information, that the display screen is rotated in the plane including the display screen; an operation detecting unit configured to specify a specified position on the display screen, the specified position being specified through an operation by a user; a display image determining unit configured to determine, as a display image, an image included in a display region in a content image; and a display controlling unit configured to display the display image determined by the display image determining unit on the display screen, and when the rotation information is detected by the rotation detecting unit, the display image determining unit is configured to rotate, based on the rotation information, the display region around a center of rotation detected by the operation detecting unit, and determine an image included in the display region after the rotation as a new display image, the center of rotation being the specified position.

With this, the user can rotate the screen without losing a sight of the point of focus on a content image by specifying the point of focus on the content image in the screen before the rotation and causing the display content to rotate around the point of focus. That is, the user can continuously view the content before and after the rotation. Thus, continuity of the content displayed on the screen is maintained between before and after the rotation of the screen.

Moreover, for example, the operation detecting unit is configured to detect the specified position which is specified by the user bringing an object into contact with the display screen.

With this, the user can intuitively specify the point of focus on the content image using a finger of the user or an object such as a pen that is used for an input to a screen. Accordingly, the user can continuously view the content before and after the rotation. Thus, continuity of the content displayed on the screen is maintained between before and after the rotation of the screen.

Moreover, for example, when the specified position is not detected, the display image determining unit is configured to rotate the display region around a center of rotation on the display screen, and determine an image included in the display region after the rotation as a new display image, the center of rotation being a predetermined position.

With this, it is possible to rotate the display content around the predetermined position on the screen when the user does not explicitly specify the point of focus on the content image. By setting in advance the predetermined position to a position on the screen desired by the user, the user needs not specify a point of focus every time the user rotates the screen, thereby improving convenience.

Moreover, for example, the rotation detecting unit is configured to detect, as the rotation information, a rotation angle by which the display screen is rotated in the plane including the display screen, and the display image determining unit is configured to rotate the display region by the rotation angle included in the rotation information, and determine an image included in the display region after the rotation as a new display image.

With this, it is possible to rotate the display content around the point of focus only by the angle equal to the angle by which the display screen is rotated.

Moreover, for example, the display image determining unit is configured to clip the display region in the content image which is larger than the display screen, and determine an image included in the clipped display region as the display image.

With this, it is possible to determine a partial region of the content image which is larger than the screen of the display device as the display region, and to change the display region to include a different part of the content image while maintaining the point of focus of the user within the screen. Thus, continuity of the content displayed on the screen is maintained between before and after the rotation of the screen.

Moreover, a display method according to an aspect of the present disclosure is a display method for a display device including a display screen which is fixed to the display device and displays a partial region of an image, the display method including: specifying a position in the partial region of the image displayed on the display screen; detecting rotation information which indicates a rotation of the display device in a plane including the display screen; and updating display content on the display screen to display the partial region of the image after the rotation on the display screen by rotating, based on the rotation information detected in the detecting, the partial region of the image around the position specified in the specifying. Moreover, a display method according to another aspect of the present disclosure is a display method for a display device including a display screen, the display method including: detecting, as the rotation information, that the display screen is rotated in the plane including the display screen; specifying a specified position on the display screen, the specified position being specified through an operation by a user; determining, as a display image, an image included in a display region in a content image; and displaying the display image determined in the determining on the display screen, and when the rotation information is detected in the detecting of the rotation information, in the determining, based on the rotation information, the display region is rotated around a center of rotation detected in detecting of the specified position, and an image included in the display region after the rotation is determined as a new display image, the center of rotation being the specified position.

This method provides the same advantage as that of the above display device.

These general and specific aspects may be implemented using a system, a method, an integrated circuit, a computer program, or a computer-readable recording medium such as a CD-ROM, or any combination of systems, methods, integrated circuits, computer programs, or computer-readable recording media.

Hereinafter, a display device according to an aspect of the present disclosure is described in greater detail with reference to the accompanying drawings.

It is to be noted that the embodiment described below shows a general or specific example of the present disclosure. Therefore, the numerical values, shapes, materials, structural elements, the arrangement and connection of the structural elements, steps, the processing order of the steps etc. shown in the following exemplary embodiment are mere examples, and therefore do not limit the scope of the present disclosure. Moreover, among the structural elements in the following exemplary embodiment, structural elements not recited in any one of the independent claims are described as arbitrary structural elements.

### Embodiment

A non-limiting embodiment shows an example in which a point on a display screen on which a user was focusing before the rotation is continuously displayed in the display screen after the rotation when an orientation of the display screen which displays a part of a content image is changed by the rotation.

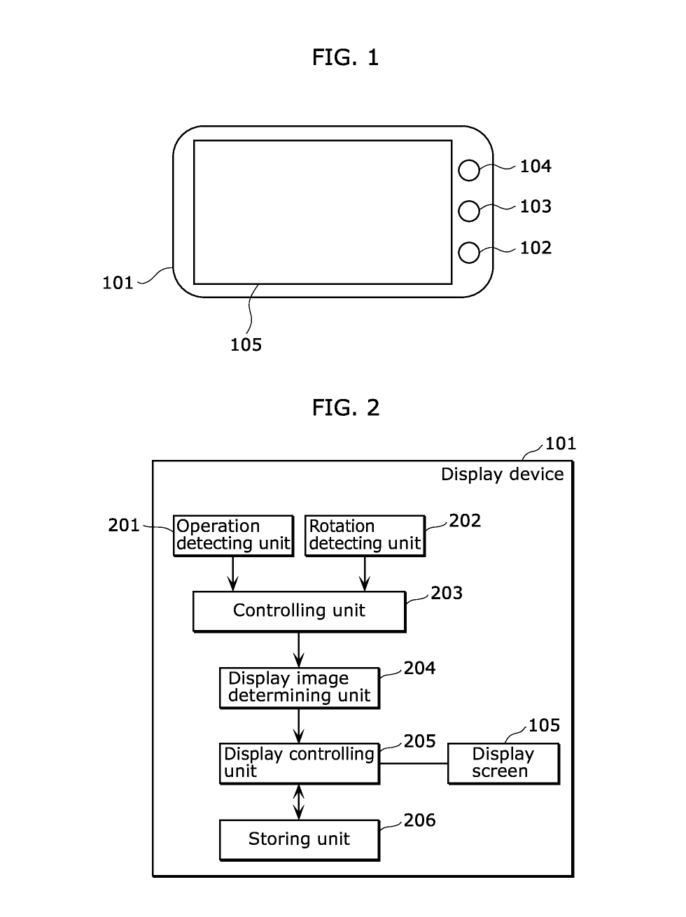

FIG. 1 is a diagram showing an example of a hardware configuration of a display device 101 according to this embodiment.

In FIG. 1, the display device 101 includes a button 102, a button 103, a button 104, and a display screen 105.

The button 102 is a “menu button”. When the button 102 is pressed through an operation by the user, the display device 101 displays a menu screen assigned to a currently displayed image.

The button 103 is a “home button”. When the button 103 is pressed through an operation by the user, the display device 101 closes the currently displayed image and displays a main screen.

The button 104 is a “return button”. When the button 104 is pressed through an operation by the user, the display device 101 closes the currently displayed image and displays the last displayed image.

The display screen 105 displays an image of content such as map data (a content image). On the display screen 105, an operation detecting unit is disposed (not shown). For example, the operation detecting unit is a touch panel, and detects a contact between the display screen and a finger.

FIG. 2 is a block diagram showing an example of a configuration of the display device 101 according to the embodiment of the present disclosure. As shown in FIG. 2, the display device 101 includes an operation detecting unit 201, a rotation detecting unit 202, a controlling unit 203, a display image determining unit 204, a display controlling unit 205, a storing unit 206, and the display screen 105.

The operation detecting unit 201 detects a contact position contacted by the finger of the user on the screen, calculates position information indicating a coordinate position on the display screen 105, and outputs the position information to the controlling unit 203. For example, the operation detecting unit 201 is implemented as a touch panel. Here, the contact position includes a contact position between the screen and an object, when the object other than the finger of the user contacts the screen through an operation by the user. The object other than the finger of the user is, for example, a stylus or a pen used for an input to a screen. Moreover, any operation may be used for specifying the contact position. An operation for specifying the contact position may be, for example, a single tap, a double tap, or such an operation as to draw a predetermined figure. Here, an operation to which a function executed in a currently used application is not assigned may be used to perform the specifying of the contact position.

The rotation detecting unit 202 detects that the orientation of the display device 101 is changed, and outputs rotation information indicating that the screen is rotated, to the controlling unit 203. The rotation detecting unit 202 is, for example, implemented as an acceleration sensor. It is to be noted that the rotation information is, for example, information indicating a display orientation of the screen after the change.

The controlling unit 203 determines a center point of rotation (hereinafter also referred to as a center point) in rotating a display image based on information provided from the operation detecting unit 201 and the rotation detecting unit 202, and outputs center point information and the rotation information to the display image determining unit 204.

The display image determining unit 204 determines the display image to be displayed on the display screen 105 according to the center point information and the rotation information.

The display controlling unit 205 reads, from the storing unit 206, data that is based on the coordinate position of the image determined by the display image determining unit 204 and displays the data on the display screen 105.

The storing unit 206 stores original data of the display content (content image) to be displayed on the display screen 105 (hereinafter also referred to as original data).

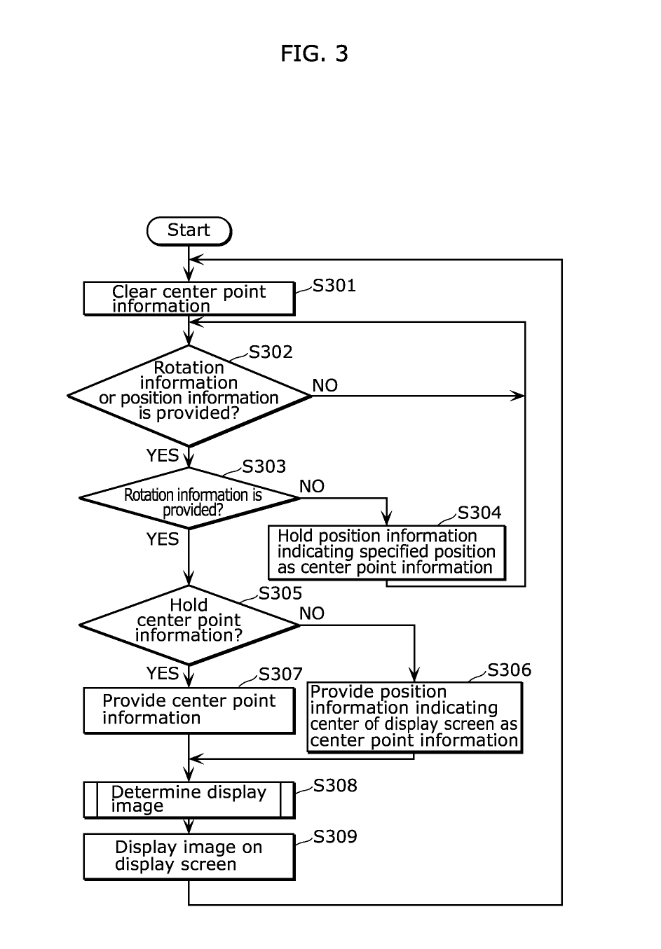

The following describes an operation of the display device 101 according to this embodiment. FIG. 3 is a flowchart showing an example of operations of the display device 101.

First, the controlling unit 203 clears the center point information (Step S301).

Next, the controlling unit 203 determines whether or not information is provided from the operation detecting unit 201 or the rotation detecting unit 202 (Step S302). The controlling unit 203 repeats the operation of Step S302 until the information is provided.

When it is detected in Step S302 that any information is provided (YES in Step S302), the controlling unit 203 determines whether or not the provided information is the rotation information provided from the rotation detecting unit 202 (Step S303).

When it is determined that the information provided in Step S302 is not the rotation information (NO in Step S303), the controlling unit 203 determines that the provided information is the position information from the operation detecting unit 201. The controlling unit 203 holds the provided position information as the center point information (Step S304), and then the process proceeds to Step S302.

When it is determined that the rotation information is provided in Step S303 (YES in Step S303), the controlling unit 203 determines whether or not the center point information is held therein (Step S305).

When it is determined that the center point information is not held in Step S305 (NO in Step S305), the controlling unit 203 determines a predetermined position on the display screen 105 as the center point. The controlling unit 203 provides the rotation information and the center point information indicating coordinates of the determined center point to the display image determining unit 204 (Step S306). It is to be noted that the predetermined position is a position that is determined in advance on the display screen and is set to, for example, a point in center of the display screen 105.

When it is determined that the center point information is held in Step S305 (YES in Step S305), the controlling unit 203 provides the center point information and the rotation information held therein to the display image determining unit 204 (Step S307).

Next, the display image determining unit 204 determines coordinates and a display range of the next image to be displayed based on the coordinates of the current display position, and the center point information and the rotation information provided from the controlling unit 203, and provides information indicating the result of the determination to the display controlling unit 205 (Step S308). Detailed operations of the display image determining unit 204 in Step S308 will be described later.

Next, the display controlling unit 205 reads data from the storing unit 206 based on the information indicating the coordinates and the display range provided from the display image determining unit 204, and displays the data on the display screen 105 (Step S309). Subsequently, the process returns to Step S301.

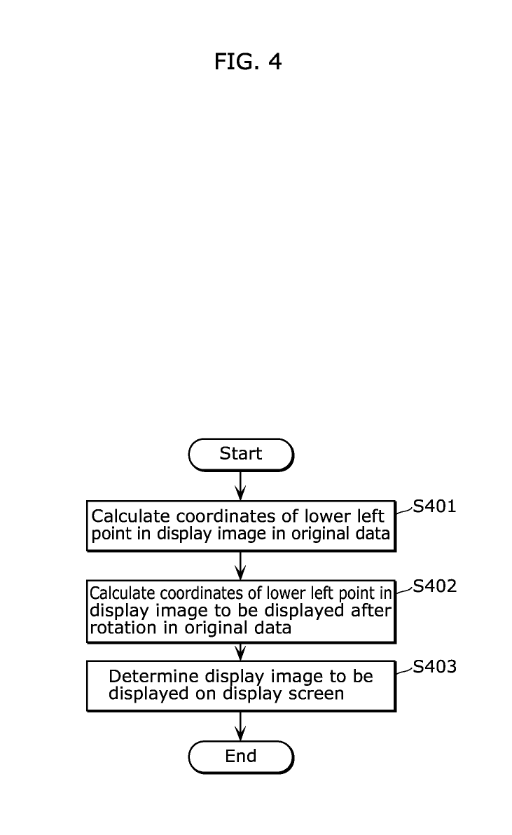

Detailed operations of the display image determining unit 204 in Step S308 are described with reference to FIG. 4. FIG. 4 is a flowchart showing operations of the display image determining unit 204 in Step S308.

First, the display image determining unit 204 calculates coordinates of a reference point in a display image that is currently displayed on the display screen 105 in the original data stored in the storing unit 206 (Step S401). Here, any point in the display image can be used as the reference point in the display image. The following describes the case where a lower left end (lower left point) in the display image is used as the reference point.

Next, the display image determining unit 204 calculates coordinates of the lower left point in the display image to be displayed after the rotation using the center point information provided from the controlling unit 203, the information indicating coordinates detected in Step S401, and the rotation information (Step S402).

Next, the display image determining unit 204 determines the display image to be displayed on the display screen 105 using the information indicating coordinates calculated in Step S402 and the rotation information (Step S403).

The following specifically describes operations of the display device 101 according to this embodiment taking the case of, for example, displaying map data on the display device 101 as content image. Here, for example, the case where the orientation is switched from the horizontal orientation to the vertical orientation as a result of the user changing the way to hold the display device 101 is described with reference to the drawings.

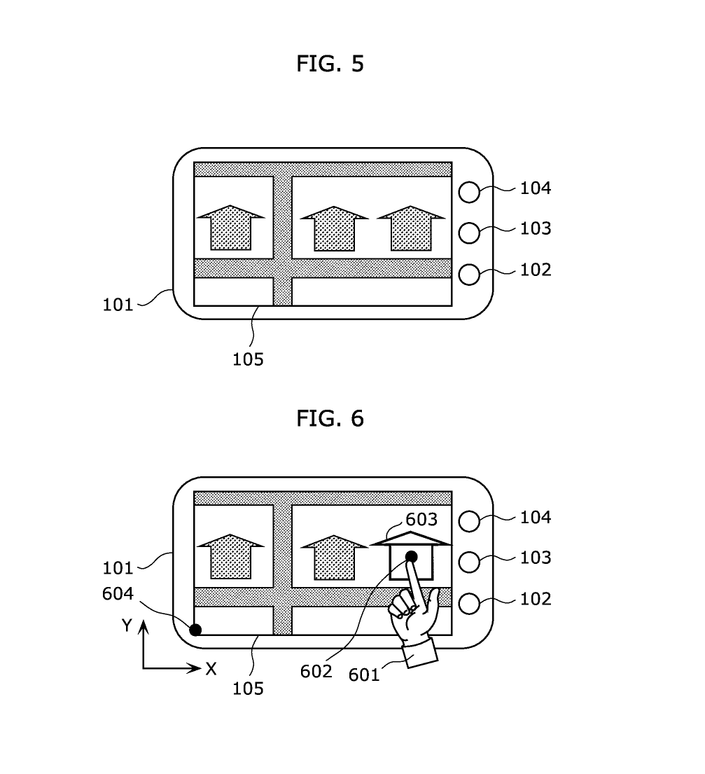

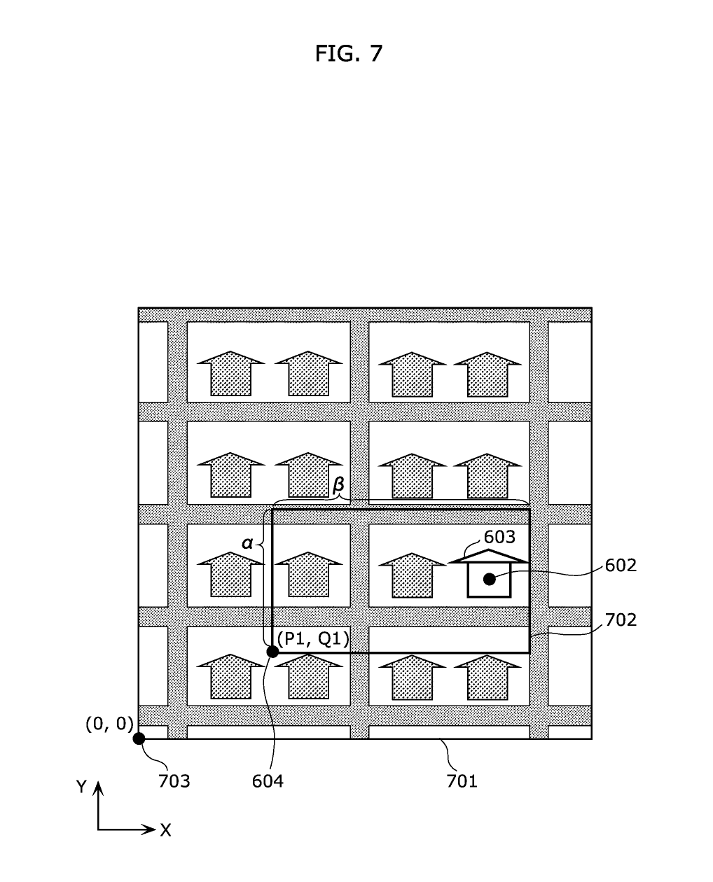

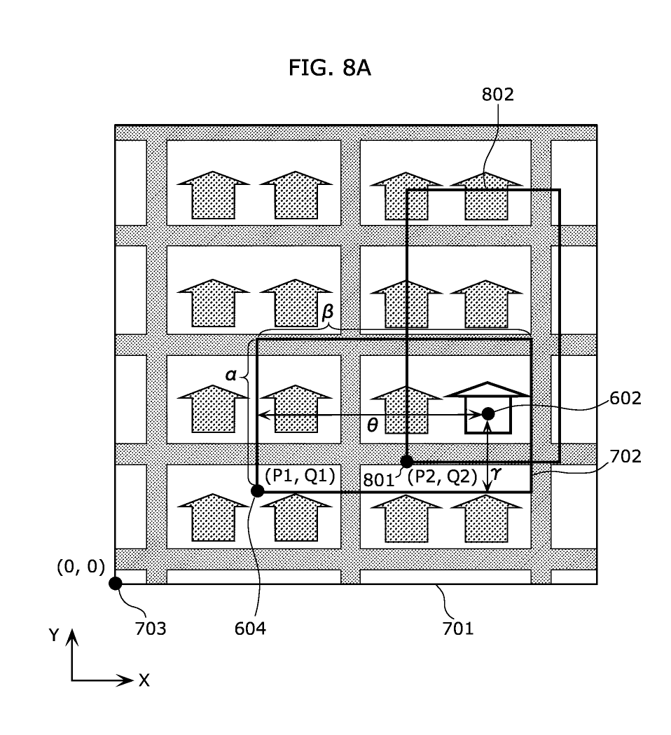

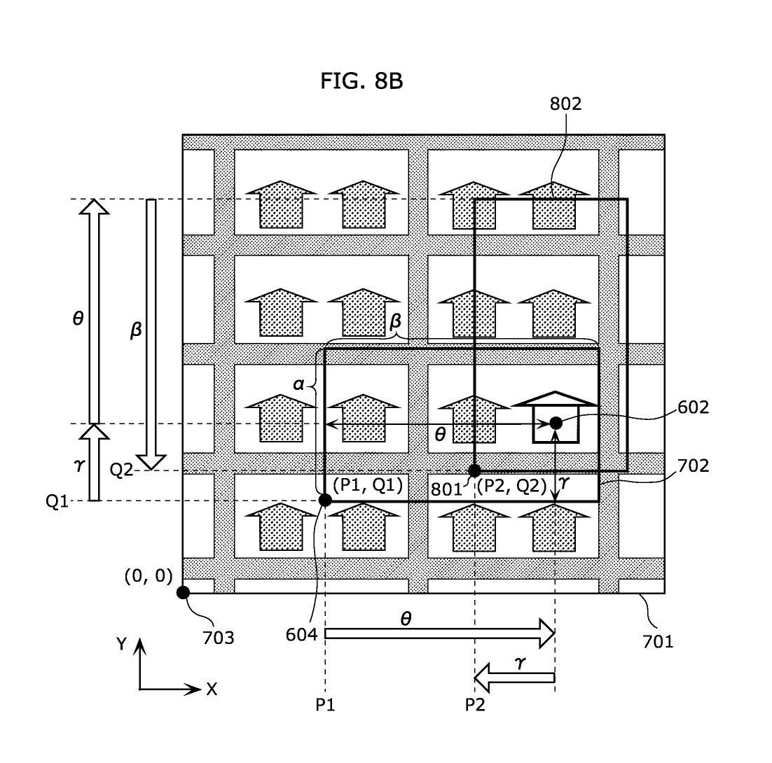

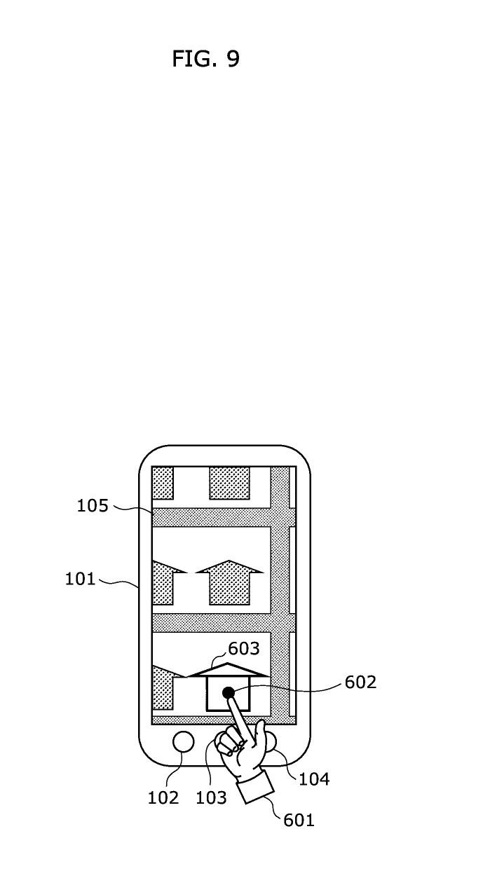

FIG. 5 is a diagram showing an example of display content on the display screen 105 in the display device 101. In FIG. 5, the display device 101 shows map data on the display screen 105. FIG. 6 is a diagram for explaining operations to set a point of focus. FIG. 7 is a diagram showing the original data of the display content stored in the storing unit 206. FIG. 8A is a diagram showing display images before and after the rotation. FIG. 9 is a diagram showing an example of the display content when the way to hold the display device 101 is changed to the vertical orientation.

At first, as shown in FIG. 5, the user holds the display device 101 in such a way that the display orientation of the screen is in the horizontal orientation, and the display screen 105 displays a map. The map displayed on the display screen 105 is a part of the original data of the display content stored in the storing unit 206.

Next, as shown in FIG. 6, the user determines the center of rotation by selecting a point of focus on the display screen 105. Here, detailed description is given of the case where the user selects, as the point of focus, a house 603 on the map displayed on the display screen 105 in the display device 101.

In FIG. 6, the origin (0, 0) is set to a point 604 which is the lower left point on the display screen 105, and a rightward direction from the point 604 is an X axis direction and an upward direction from the point 604 is a Y axis direction. The user selects the center point by tapping with a finger 601 the house 603 which is the point of focus. The display device 101 may explicitly show the center point to the user, for example, by displaying a colored point 602 on the part selected as the center point. It is to be noted that the center point is not necessarily displayed as a point, but may be displayed in any manner to explicitly show a position specified as the center point. It is to be noted that although the point of focus of the user is selected by tapping with the finger 601 of the user in the above description, the selection may be performed with an object other than the finger. Here, the object other than the finger is, for example, a stylus or a pen used for an input to a screen.

At this time, the operation detecting unit 201 detects coordinates of the center point 602 taking the point 604 as the origin, and provides information indicating the detected coordinates (θ, γ) to the controlling unit 203 as the position information. The controlling unit 203 holds the provided information indicating the coordinates of the center point 602 as the center point information.

Next, the user changes the way to hold the display device 101 such that the display orientation of the screen is changed from the horizontal orientation to the vertical orientation. The rotation detecting unit 202 detects that the display device 101 is rotated, and provides the rotation information to the controlling unit 203. It is to be noted that the rotation information may be information indicating a rotation direction and a rotation angle. Moreover, the rotation information may be information indicating an orientation before the rotation and an orientation after the rotation, for example, indicating a rotation from the horizontal orientation to the vertical orientation. Moreover, the rotation information may be information indicating only the orientation after the rotation. In the case of indicating only the orientation after the rotation, it is assumed that the state before the rotation is held by the controlling unit 203.

Upon receiving the rotation information from the rotation detecting unit 202, the controlling unit 203 determines whether or not the center point information is held therein. In this case, since holding the information indicating the coordinates of the center point 602 as the center point information, the controlling unit 203 provides the center point information held therein and the rotation information to the display image determining unit 204.

Upon receiving the center point information and the rotation information from the controlling unit 203, the display image determining unit 204 performs the following processing. First, the display image determining unit 204 calculates the coordinates of the point 604 which is the origin on the display screen 105 in the original data of the display content stored in the storing unit 206. FIG. 7 is a diagram showing map data 701 that is the original data of the display content stored in the storing unit 206. In FIG. 7, the origin (0, 0) is set to a point 703, and a rightward direction from the point 703 is an X axis direction and an upward direction from the point 703 is a Y axis direction.

On the map data 701 in this embodiment, houses and streets are shown. In FIG. 7, the part in a region 702 corresponds to the display image on the display screen 105 in the display device 101. The display image determining unit 204 detects coordinates (P1, Q1) of the point 604 on the map data 701. Here, given that the short side of the display screen 105 has a length of α and the long side has a length of β, the region 702 corresponds to data of a rectangular region having a length of β along the X axis and a length of α along the Y axis from the coordinates (P1, Q1) in the original data.

Next, the display image determining unit 204 calculates coordinates (P2, Q2) of a position that is to be the origin of the display screen 105 after the rotation on the map data 701, using the center point information and the rotation information received from the controlling unit 203, and the information indicating the coordinates of the point 604.

FIG. 8A is a diagram showing image regions before and after a rotation displayed on the display screen 105. In FIG. 8A, the rightward direction from the point 703 is an X axis direction, and the upward direction from the point 703 is a Y axis direction.

In FIG. 8A, a point 801 is a point to be the origin on the display screen 105 after the rotation, and a region 802 is an image region to be displayed on display screen 105 after the rotation. As shown in FIG. 8A, the region 802 is obtained by rotating the region 702 around the point 602 so that the display screen is in the vertical orientation. FIG. 8B is an illustration diagram of a process of calculating the image regions before and after the rotation of the display screen. As shown in FIG. 8B, the coordinates (P2, Q2) of the point 801 can be calculated by (P1+θ−γ, Q1+θ+γ−β).

The display image determining unit 204 determines, as a display image to be displayed, the region 802 having a length of α along the X axis and a length of β along the Y axis from the calculated coordinates (P2, Q2).

FIG. 9 shows the display device 101 after the rotation. As shown in FIG. 9, the display screen is rotated around the center point 602 selected by the user, and the house 603 on which the user was focusing is displayed within the screen. As a result, the user can change the display orientation of the screen without losing the sight of the point of focus.

The following describes the case where the user does not set a center point.

First, given that the user changes the way to hold the display device 101 from the horizontal orientation as shown in FIG. 5 to the vertical orientation. The rotation detecting unit 202 detects that the display device 101 is rotated, and provides the rotation information to the controlling unit 203. When receiving the rotation information from the rotation detecting unit 202, the controlling unit 203 determines whether or not the center point information is held therein. In this case, since not holding the center point information, the controlling unit 203 sets the center point to a predetermined position on the display screen 105. It is to be noted that the predetermined position is a position that is determined in advance on the display screen and may be set to, for example, a point in the center of the display screen 105. Hereinafter, the case of setting the predetermined position to the point in the center of the display screen 105 is described.

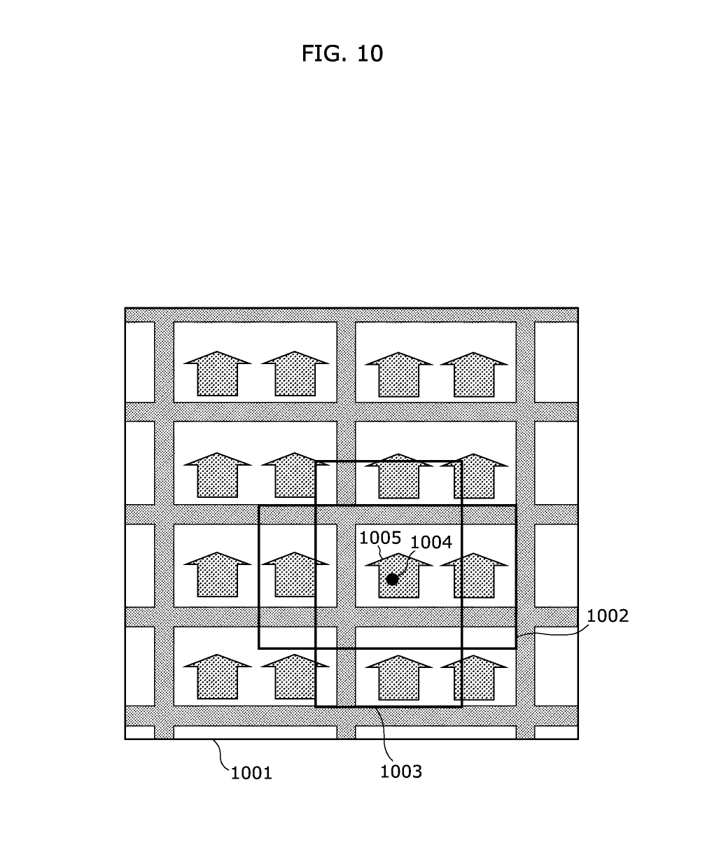

FIG. 10 is a diagram showing display image regions in the original data in the case where the center point is set to the center of the display screen.

In FIG. 10, a display image 1002 is a display image before the rotation, a display image 1003 is a display image after the rotation, and a point 1004 is the point in the center of the display image 1002 in an original data 1001 of the display content. The display image 1002 is an image displayed on the display screen 105 in a state shown in FIG. 5. In this case, the point 1004 which is to be the center point of rotation is fixed to the center of the screen, so that the center point of rotation is set to a house 1005 which is positioned in the center of the display image 1002.

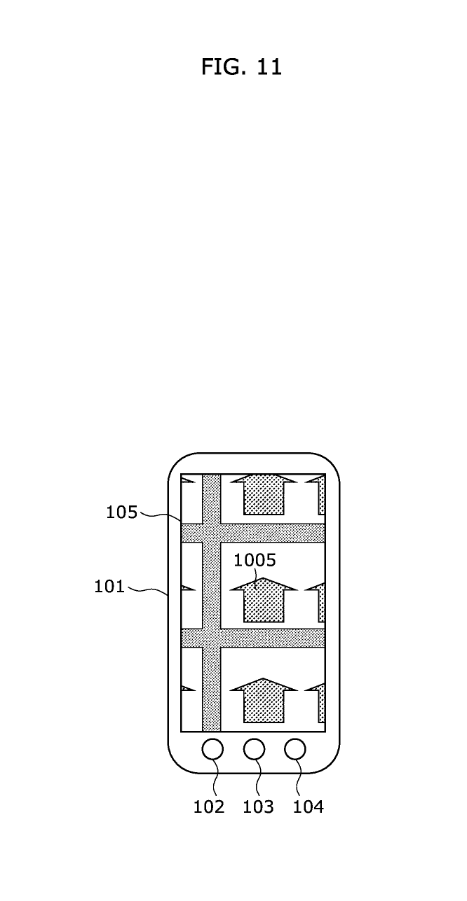

FIG. 11 is a diagram showing an example of the display content on the display screen of the display device. In FIG. 11, the display image 1002 is displayed on the display screen 105 in the display device 101. As shown in FIG. 11, the house 1005 in the center of the display screen 105 before the rotation is displayed in the center of the display screen 105 after the rotation, too.

As described above, according to an embodiment of the present disclosure, when changing the display orientation of the content including map information, a newspaper, or a magazine, the user can view the content continuously. That is, it is possible to implement a display device in which continuity of the content is maintained between before and after the rotation of the screen.

It is to be noted that although an example in which the way to hold the display device is changed from the horizontal orientation to the vertical orientation has been described in this embodiment, the case of changing from the vertical orientation to the horizontal orientation can be implemented in the same manner.

It is to be noted that although an example in which the screen of the display device is rotated by 90 degrees from the horizontal orientation to the vertical orientation has been described in this embodiment, the case where the rotation angle between the vertical orientation and the horizontal orientation is smaller than 90 degrees can be implemented in the same manner. Furthermore, even when the rotation angle between the vertical orientation and the horizontal orientation is smaller than 90 degrees, the screen of the display device may be rotated by 90 degrees provided that the rotation angle is more than or equal to a predetermined angle. In such a case, it may be that the screen of the display device is not rotated when the rotation angle is less than or equal to the predetermined angle.

It is to be noted that although an example in which a part of a content image is displayed on the entire display screen of the display device has been described in this embodiment, it is also possible to display the part of the content image in a part of the display screen in the same manner. In such a case, the part of the display screen is used as the display screen according to this embodiment.

As described above, with the display device according to an aspect of the present disclosure, the user can rotate the screen without losing the sight of the point of focus on a content image by specifying the point of focus on the content image in the screen before the rotation and causing the display content to rotate around the point of focus which is the center of rotation. That is, the user can continuously view the content before and after the rotation. Thus, continuity of the content displayed on the screen is maintained between before and after the rotation of the screen.

Moreover, the user can intuitively specify a point of focus on the content image through contact using a finger of the user or an object such as a pen that is used for an input to the screen. Accordingly, the user can continuously view the content before and after the rotation. Thus, continuity of the content displayed on the screen is maintained between before and after the rotation of the screen.

Moreover, when the user does not explicitly specify a point of focus on the content image, it is possible to rotate the display content around the predetermined position which is the center of rotation on the screen. By setting the predetermined position to a position desired by the user on the screen, the user needs not specify a point of focus every time the user rotates the screen, thereby improving convenience.

Moreover, it is possible to rotate the display content around the point of focus only by the angle equal to the angle by which the display screen is rotated.

Moreover, a partial region of the content image which is larger than the screen of the display device is determined as the display region, and, when the screen is rotated, it is possible to change the display region to include a different partial region of the content image while maintaining the point of focus of the user within the screen. Thus, continuity of the content displayed on the screen is maintained between before and after the rotation of the screen.

It is to be noted that each of the structural elements in the above-described embodiment may be configured in the form of an exclusive hardware product, or may be realized by executing a software program suitable for the structural element. Each of the structural elements may be realized by means of a program executing unit, such as a CPU and a processor, reading and executing the software program recorded on a recording medium such as a hard disk and a semiconductor memory. Here, the software program for realizing the display device according to the embodiment is a program described below.

The program causes a computer to execute a display method for a display device including a display screen which is fixed to the display device and displays a partial region of an image, the display method including: specifying a position in the partial region of the image displayed on the display screen; detecting rotation information which indicates a rotation of the display device in a plane including the display screen; and updating display content on the display screen to display the partial region of the image after the rotation on the display screen by rotating, based on the rotation information detected in the detecting, the partial region of the image around the position specified in the specifying. Moreover, the program causes a computer to execute a display method for a display device including a display screen, the display method including: detecting, as the rotation information, that the display screen is rotated in the plane including the display screen; specifying a specified position on the display screen, the specified position being specified through an operation by a user; determining, as a display image, an image included in a display region in a content image; and displaying the display image determined in the determining on the display screen, and when the rotation information is detected in the detecting of the rotation information, in the determining, based on the rotation information, the display region is rotated around a center of rotation detected in detecting of the specified position, and an image included in the display region after the rotation is determined as a new display image, the center of rotation being the specified position.

Although the display device according to an aspect or aspects of the present disclosure has been described based on an exemplary embodiment, the present disclosure is not limited to these embodiments. Various modifications to the embodiment that are conceived by the person skilled in the art and other embodiments obtainable by combining the structural elements in different embodiments without materially departing from the scope of the present disclosure may be included within the scope of an aspect or aspects of the present disclosure.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is applicable to an information distribution device, an information display terminal, a mobile terminal, an information distribution system or the like which are connected to a network, and is specifically useful in a portable information display terminal for personal use.

1. A display device comprising:
a display screen which is fixed to the display device and displays a partial region of an image;
a specifying unit configured to specify a position in the partial region of the image displayed on the display screen;
a detecting unit configured to detect rotation information which indicates a rotation of the display device in a plane including the display screen; and
an updating unit configured to update display content on the display screen to display the partial region of the image after the rotation on the display screen by rotating, based on the rotation information detected by the detecting unit, the partial region of the image around the position specified by the specifying unit,
wherein the updating unit is configured to maintain the position on the display screen before the rotation of the partial region of the image even after the rotation when updating the display content, the position being specified by the specifying unit.

2. The display device according to claim 1,
wherein the detecting unit includes a rotation detecting unit configured to detect, as the rotation information, that the display screen is rotated in the plane including the display screen,
the specifying unit includes an operation detecting unit configured to specify the position by detecting a specified position on the display screen, the specified position being specified through an operation by a user,
the updating unit includes:
a display image determining unit configured to determine, as a display image, an image included in a display region in a content image; and
a display controlling unit configured to display the display image determined by the display image determining unit on the display screen, and
when the rotation information is detected by the rotation detecting unit, the display image determining unit is configured to rotate, based on the rotation information, the display region around a center of rotation detected by the operation detecting unit, and determine an image included in the display region after the rotation as a new display image, the center of rotation being the specified position.

3. The display device according to claim 2,
wherein the operation detecting unit is configured to detect the specified position which is specified by the user bringing an object into contact with the display screen.

4. The display device according to claim 2,
wherein when the specified position is not detected, the display image determining unit is configured to rotate the display region around a center of rotation on the display screen, and determine an image included in the display region after the rotation as a new display image, the center of rotation being a predetermined position.

5. The display device according to claim 2,
wherein the rotation detecting unit is configured to detect, as the rotation information, a rotation angle by which the display screen is rotated in the plane including the display screen, and
the display image determining unit is configured to rotate the display region by the rotation angle included in the rotation information, and determine an image included in the display region after the rotation as a new display image.

6. The display device according to claim 2,
wherein the display image determining unit is configured to clip the display region in the content image which is larger than the display screen, and determine an image included in the clipped display region as the display image.

7. A display method for a display device including a display screen which is fixed to the display device and displays a partial region of an image, the display method comprising:
specifying a position in the partial region of the image displayed on the display screen;
detecting rotation information which indicates a rotation of the display device in a plane including the display screen; and
updating display content on the display screen to display the partial region of the image after the rotation on the display screen by rotating, based on the rotation information detected in the detecting, the partial region of the image around the position specified in the specifying,
wherein in the updating, the position on the display screen before the rotation of the partial region of the image is maintained even after the rotation when updating the display content, the position being specified by the specifying unit.

8. A non-transitory computer-readable recording medium having a computer program recorded thereon for causing a computer to execute the display method according to claim 7.
